(19) United States
(12) Patent Application Publication
(10) Pub. No.: US 2008/0085987 A1
(43) Pub. Date: Apr. 10, 2008

(54) METHOD OF PRODUCING A URETONIMINE-MODIFIED ISOCYANATE COMPOSITION

(76) Inventors: Thomas Savino, Northville, MI (US); Sandra Bananto, Dearborn, MI (US); Nikolay Lebedinski, West Bloomfield, MI (US)

Correspondence Address: BASF AKTIENGESELLSCHAFT, CARL-BOSCH STRASSE 38, 67056 LUDWIGSHAFEN, LUDWIGSHAFEN, 69056, omitted

(21) Appl. No.: 11/538,835

(22) Filed: Oct. 5, 2006

(51) Int. Cl. C08G 18/00

(52) U.S. Cl. 528/44

(57) ABSTRACT

A method produces a uretonimine-modified isocyanate composition having increased low-temperature tolerance. The method comprises providing a polyisocyanate composition comprising 4,4′-diphenylmethane diisocyanate (MDI) and reacting the polyisocyanate composition at a temperature of from about 90° C. to about 115° C. in the presence of a catalyst, and optionally a co-catalyst, such that the isocyanate groups react to form uretonimine oligomers. The reaction of the polyisocyanate composition is quenched with a quenching agent to produce an intermediate composition having an intermediate isocyanate value from about 25.5 to about 28.5. A second polyisocyanate composition is added to the intermediate composition in an amount sufficient to produce the uretonimine-modified isocyanate composition having a final isocyanate value of from about 29.0 to about 29.5.

### BACKGROUND OF THE INVENTION

1. Field of the Invention

The subject invention relates to a method of producing a uretonimine-modified isocyanate composition having increased low-temperature tolerance and stability.

2. Description of the Related Art

Polyisocyanate compositions including a high concentration of diphenylmethane diisocyanate (“MDI”), particularly 4,4′-MDI are useful for various cellular and non-cellular polyurethane applications. However, a high concentration of 4,4′-MDI often poses a unique processing problem because 4,4′-MDI is normally a solid material at room temperature, i.e., about 25° C. Therefore, the material has to be melted and maintained in order to be useful as a liquid and used in the cellular and non-cellular polyurethane applications.

Unfortunately, MDI compositions having relatively high levels of 4,4′-MDI are also known to have a limited shelf-life due to the formation of diphenylmethane uretdione, otherwise referred to herein as uretdione. Over time, uretdione continues to form in MDI compositions containing 4,4′-MDI. Since uretdione has limited solubility in most MDI compositions, it will tend to precipitate out as a solid. For example, pure 4,4′-MDI compositions maintained at about 43° C. for 14 days have exhibited uretdione concentrations above the generally acceptable saturation concentration of about 0.45%, resulting in the precipitation of uretdione from solution as insoluble white solids. The formation of high concentrations of uretdione renders the MDI compositions substantially useless in many cellular and non-cellular polyurethane applications.

The substantially insoluble uretdione precipitate also causes problems with processing equipment. Specifically, the precipitate clogs the processing equipment, which requires the processing to be stopped. The processing equipment must then be removed from service and cleaned. Even after the processing equipment is cleaned, the precipitate will eventually form and continue to clog the processing equipment resulting in additional service being required. Alternatively, the precipitate may be filtered from the composition. However, additional filtering equipment is required and the removal of the precipitate remains an ongoing problem.

Interestingly, the uretdione formation reaction is both temperature and phase dependent. For example, as the temperature of a 4,4′-MDI composition is increased above about 43° C., the rate of uretdione formation increases. Furthermore, the rate of uretdione formation is accelerated when the MDI is in the solid state as compared with a liquid composition at 43° C., such formation being generally attributed to the alignment of the isocyanate groups in the crystal lattice structure. When the temperature of liquid 4,4′-MDI is lowered and approaches the melting point of about 39 to 43° C., solid 4,4′-MDI begins to form. Along with the formation of solid 4,4′-MDI, insoluble uretdione precipitate rapidly forms, such that when the temperature is subsequently raised above 43° C., solid particles of uretdione remain, rendering the product useless for most cellular and non-cellular polyurethane applications.

In view of the temperature and phase dependency of uretdione formation, MDI compositions are maintained in a liquid state having no solids at a temperature of less than 50° C. to minimize the formation of uretdione. However, this desired solids-free liquid state is difficult to maintain and while this temporarily delays the appearance of insoluble precipitate; the uretdione is still being formed at a certain rate. Eventually the concentration of uretdione exceeds the saturation point and insoluble uretdione solids precipitate out of solution.

### SUMMARY OF THE INVENTION AND ADVANTAGES

The subject invention provides a method of producing a uretonimine-modified isocyanate composition having increased low-temperature tolerance. The method comprises providing a first polyisocyanate composition having two or more isocyanate groups and comprising 4,4′-diphenylmethane diisocyanate (MDI). The first polyisocyanate composition is reacted at a temperature of from about 90° C. to about 115° C. and in the presence of a catalyst such that the isocyanate groups form carbodiimides for forming uretonimine and uretonimine oligomers. The reaction of the first polyisocyanate composition is quenched with a quenching agent to produce an intermediate composition having an intermediate isocyanate value of from about 25.5 to about 28.5. A second polyisocyanate composition is added to the intermediate composition in an amount sufficient to produce the uretonimine-modified isocyanate composition having a final isocyanate value of from about 29.0 to about 29.5.

The subject invention provides a low-temperature tolerant uretonimine-modified isocyanate composition that has improved long-term stability as a result of the intermediate isocyanate value and the uretonimine oligomer ratio. The uretonimine-modified isocyanate composition can be stored at temperatures substantially lower than room temperature while still remaining a liquid and while having a reduced tendency to precipitate uretdione as insoluble solids. Additionally, the uretonimine-modified isocyanate composition exhibits improved long term storage stability as a result of having lower amounts of uretdione formed.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a graph of a gel permeation chromatography (GPC) trace of a uretonimine-modified isocyanate composition formed according to the subject invention after a first time period;

FIG. 2 is a graph of a gel permeation chromatography (GPC) trace of the uretonimine-modified isocyanate composition after a second time period; and

FIG. 3 is a graph of uretonimine ratio versus intermediate isocyanate value of the intermediate composition for the subject invention.

### DETAILED DESCRIPTION OF THE INVENTION

A method of producing a uretonimine-modified isocyanate composition having increased low-temperature tolerance is disclosed. The method of producing the uretonimine-modified isocyanate composition includes the step of providing a first polyisocyanate composition having two or more isocyanate groups and comprising 4,4′-diphenylmethane diisocyanate (MDI), which is also referred to as bis(4-isocyanatophenyl)methane or 4,4′-methylenediphenyl diisocyanate. The 4,4′-MDI is present in an amount of from about 85 to less than 98 parts by weight based on 100 parts by weight of the first polyisocyanate composition. Preferably, the 4,4′-MDI is present in an amount of from about 85 to about 95 parts by weight, and more preferably from about 90 to about 95 parts by weight, both based on 100 parts by weight of the first polyisocyanate composition. As used herein, the terms “isocyanate composition” and “composition” are intended to refer to the uretonimine-modified isocyanate composition.

As understood by those of ordinary skill in the art, 4,4′-MDI is normally a solid at room temperature, i.e., about 25° C. The 4,4′-MDI, therefore, has to be melted and maintained at about 45° C. in order to be useful as a liquid. Further, the liquid 4,4′-MDI reacts to form undesirable byproducts when stored over a period of time. This is particularly true when large amounts of 4,4′-MDI are stored in storage tanks either outdoors or indoors. Diphenylmethane uretdione, or uretdione, is formed from the dimerization of two molecules of 4,4′-MDI and is shown below as 1,3-bis(4-(4-isocyanatobenzyl)phenyl)-1,3-diazetidine-2,4-dione.

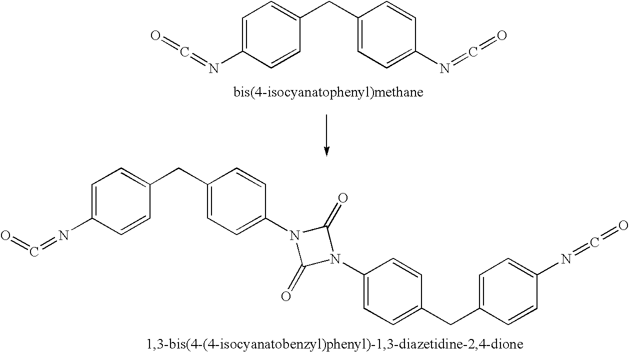

The uretdione precipitates out from the first polyisocyanate composition as a white solid. The formation of the uretdione is irreversible and once the uretdione is formed, the presence of the uretdione causes various processing problems that may require filtration. For example, processing equipment such as pumps become clogged by the uretdione solids, which requires downtime and cleaning to remove the uretdione from the pumps. Furthermore, uretdione may precipitate out of liquid 4,4-MDI if the temperature drops much below 40° C.

Generally, in addition to the 4,4′-MDI, the first polyisocyanate composition may also comprise 2,4′-MDI, 2,2′-MDI, polymeric MDI, and other isomers. The 2,4′-MDI and the 2,2′-MDI isomers are less reactive than the 4,4′-MDI and when combined with 4,4′-MDI in certain ratios affords composition that are liquids at room temperature. It has previously been known to add small amounts of either the 2,4′-MDI and the 2,2′-MDI to the 4,4′-MDI to improve the stability of the first polyisocyanate composition. For example, commercially pure 4,4′-MDI has about 98 parts by weight 4,4′-MDI and up to 2 parts by weight 2,4′-MDI. The subject invention provides the 2,4′-MDI present in an amount of greater than 2 to about 15 parts by weight based on 100 parts by weight of the first polyisocyanate composition. Preferably, the 2,4′-MDI is present in an amount of from about 5 to about 15 parts by weight, and more preferably, from about 5 to about 10 parts by weight, both based on 100 parts by weight of the first polyisocyanate composition

To form the uretonimine-modified isocyanate composition, the first polyisocyanate composition is reacted at a temperature of greater than 80° C., preferably from about 90° C. to about 115° C., and more preferably from about 100° C. to about 110° C., since it was discovered that the rate of uretdione formation is especially sensitive to temperature. Most preferably, the temperature of the reaction should be maintained at about 105° C. to help ensure a lower level of uretdione in the final product. If the temperature of the reaction exceeds 115° C., higher amounts of uretdione will be present in the product, resulting in a greater tendency for uretdione to precipitate out as insoluble white solids during handling, transportation or long term storage. The temperature of the first polyisocyanate may be raised or lowered using various known devices and techniques.

Lowering the temperature of the reaction also slows the reaction rate for carbodiimide formation as well as formation of uretonimine. A slow reaction rate can lead to long reaction times, which results in the formation of higher amounts of undesirable uretdione. To achieve the desired results for the uretonimine-modified isocyanate composition, the reaction rate is increased while maintaining the temperature between about 90° C. to about 115° C.

The first polyisocyanate composition is also reacted in the presence of a catalyst such that the isocyanate groups of MDI react to first form carbodiimides. The catalyst is present in amounts of from about 2 to about 500 parts per million. The amount of catalyst depends on the reaction temperature such that the reaction temperature remains near the desired reaction temperature and that the reaction occurs in a desired amount of time. Preferably, the catalyst is present in an amount of from about 5 to about 100 parts per million. As appreciated by those of ordinary skill in the art, the catalyst may participate in the reaction and may also remain in the uretonimine-modified isocyanate composition. Alternatively, the catalyst may be removed or filtered. The catalyst catalyzes the formation of the carbodiimides and does not substantially interact with the reaction of the carbodiimides and the first polyisocyanate composition or the uretonimines.

The uretonimine-modified isocyanate compositions of the present invention may be prepared using any of the known carbodiimide-promoting compounds as catalysts. The catalyst is selected from at least one of phospholene, phospholidine, phospholene oxide, and phospholidine oxide. One example of phospholidine includes 1-phenyl phospholidine and one example of phospholidine oxides includes 1-phenyl-phospholidine-1-oxide. Other suitable catalysts include phosphate esters, such as triethylphosphate, and phosphine oxides, such as tributylphosphine oxide.

Preferred catalysts are phospholene oxides, and most preferred are phospholene 1-oxides having the following formula:

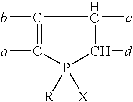

Or the isomeric formula

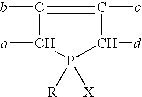

wherein a, b, c and d are each selected from one of hydrogen or hydrocarbyl from 1 to 12 carbon atoms inclusive, R is selected from one of lower alkyl or aryl and X is selected from one of oxygen or sulfur.

Representative compounds within this class of catalysts are 3-methyl-1-phenyl-3-phospholene-1-oxide, 3-methyl-1-phenyl-2-phospholene-1-oxide, 1-methyl-3-phospholene-1-oxide, 1-methyl-2-phospholene-1-oxide, 1-ethyl-3-phospholene-1-oxide, 1-ethyl-2-phospholene-1-oxide 1-phenyl-3-phospolene-1-oxide, and 1-phenyl-2-phospolene-1-oxide. Also, polymer bound catalysts, and especially polymer bound phospholene oxides, may be employed in the subject invention.

In addition, co-catalysts may also be used to ensure the desired reaction temperature and time. The co-catalyst is added in an amount of from about 50 to about 1500 parts per million, preferably from about 100 to about 1250, more preferably from about 200 to about 1000 parts per million. The co-catalyst is preferably a phosphite, comprised of aliphatic, aromatic, or mixed aliphatic and aromatic groups. Examples of preferred co-catalysts include triphenyl phosphite, tributyl phosphite, phenyl diisodecyl phosphite, and diphenyl isodecyl phosphite.

In addition, hindered phenol antioxidants, and especially 2,6-di-tert-butyl-hindered phenolic antioxidants, may be present in the first polyisocyanate composition. Examples of phenolic antioxidants include 2,6-di-tert-butyl-4methylphenol, also known as BHT, and 3-(3,5-di-tert-butyl-4-hydroxyphenyl)propanoate, available commercially as Irganox® 1076. Hindered phenolic antioxidants are commonly used as stabilizers for commercial first polyisocyanate compositions, and thus may be present when employed in forming the uretonimine-modified isocyanate composition of the subject invention. If the hindered phenolic antioxidants are not present in the first polyisocyanate composition, then they may also be added before or after the reaction to form carbodiimide, uretonimine, and uretonimine oligomers.

The first polyisocyanate composition is reacted at a temperature of from about 90° C. to about 115° C. and in the presence of a catalyst such that the isocyanate groups of MDI react to first form carbodiimides. It is to be appreciated by those of ordinary skill in the art that only a portion of the isocyanate groups may react to form the carbodiimides, however, all isocyanate groups may react. The carbodiimides can then react further with the isocyanate groups of unreacted MDI to form uretonimine structures.

Alternately, the carbodiimide may also react with the isocyanate group of another molecule of uretonimine instead of unreacted MDI, to form a higher molecular weight, uretonimine oligomer. For clarity, the term “uretonimine” is intended to mean 3-functional, six ring uretonimine oligomer because there is a single uretonimine group, as shown below. Additionally, “uretonimine oligomers” is intended to mean more than 3 functional groups, which have more than a single uretonimine group, as shown below.

In addition to reacting with MDI, other mono-, di-, tri-, tetra-isocyanates and other aromatic, aliphatic, and cycloaliphatic polyisocyanates and combinations thereof may react with the MDI. Examples of suitable monoisocyanates include phenyl isocyanates and cyclohexyl isocyanate. Examples of suitable diisocyanates include m-phenylene diisocyanate, 2,4-toluene diisocyanate, 2,6-toluene diisocyanate, mixtures of 2,4- and 2,6-toluene diisocyanate, hexamethylene diisocyanate, tetramethylene diisocyanate, cyclohexane-1,4-diisocyanate, hexahydrotoluene diisocyanate (and isomers), isophorone diisocyanate, hydrogenated diphenylmethane diisocyanate, naphthalene-1,5 diisocyanate, 1-methoxyphenyl-2,4-diisocyanate, 4,4′-biphenylene diisocyanate, 3,3′-dimethoxy-4,4′-biphenyl diisocyanate, 3,3′-dimethyl-diphenylmethane4,4′-diisocyanate. Examples of suitable triisocyanates include 4,4′,4″-triphenylmethane triisocyanate and toluene 2,4,6-triisocyanate. Examples of suitable tetraisocyanates include 4,4′-dimethyldiphenylmethane-2,2′,5,5′-tetraisocyanate and examples of suitable polymeric polyisocyanates include polymethylene polyphenylene polyisocyanate.

The uretonimines formed in the reaction are a mixture of oligomers, including 3-functional, six ring uretonimine, 4-functional, ten ring uretonimine, and 5-functional, fourteen ring uretonimine. One possible reaction of the 4,4′-MDI while in the presence of the catalyst is shown below, which results in the formation of the 3-functional, six ring oligomer, 1,3-bis(4-(4-isocyanatobenzyl)phenyl)-4-(4-(4-isocyanatobenzyl)phenylimino)-1,3-diazetidin-2-one. The first step in this reaction is the formation of a carbodiimide intermediate, N,N′-methanediylidenebis-4-(4-isocyanatobenzyl)aniline from two molecules of 4,4-MDI. The carbodiimide may react further with another molecule of 4,4′-MDI to form a 3-functional, six ring uretonimine.

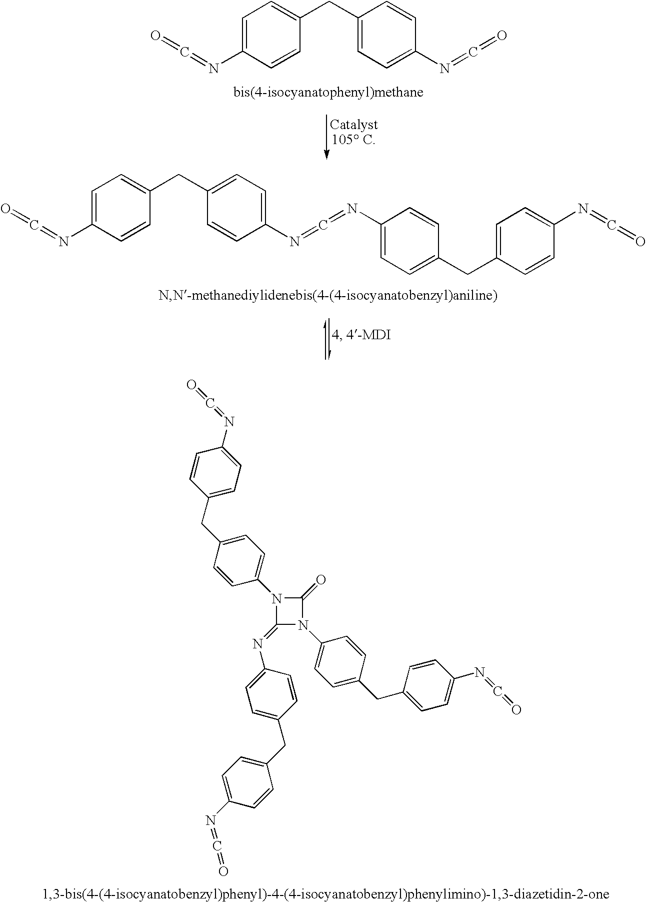

Below is an example of the 4-functional, ten ring uretonimine oligomer that may be formed as a result of the 3-functional uretonimine oligomer reacting with the carbodiimide of 4,4′-MDI.

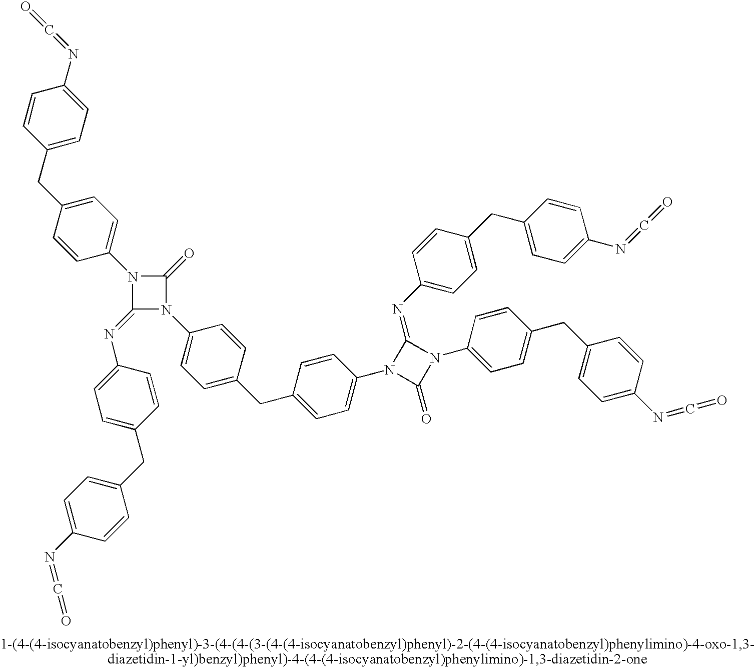

Below is an example of the 5-functional, fourteen ring uretonimine oligomer that may be formed as a result of the 4-functional uretonimine oligomer reacting with the carbodiimide of 4,4′-MDI.

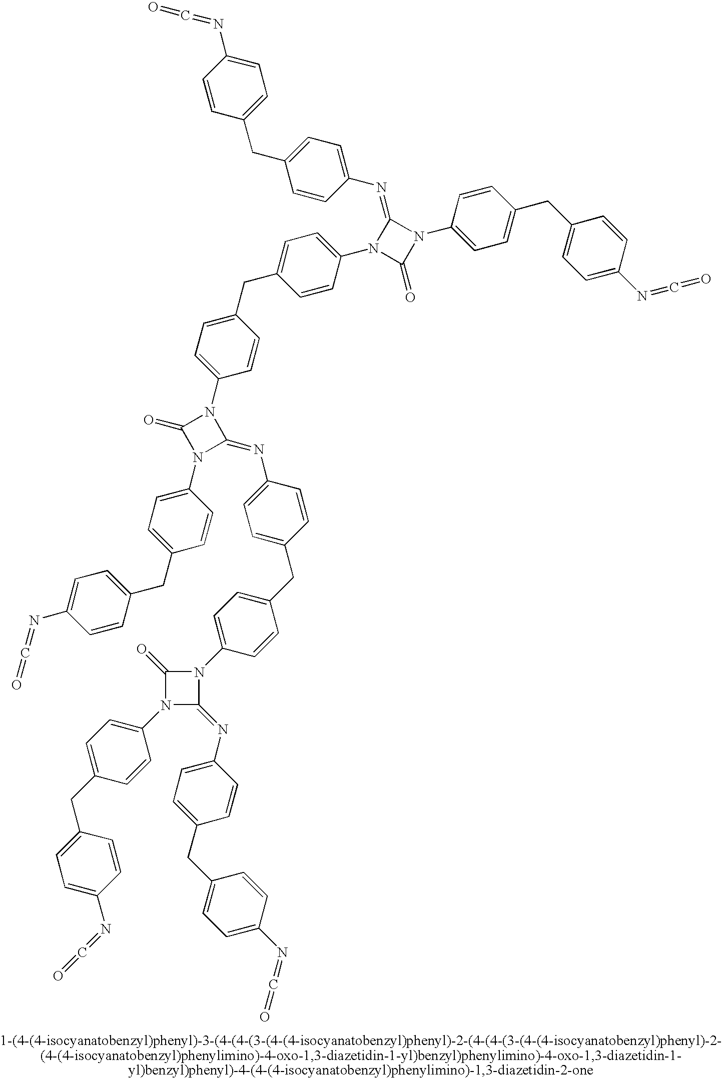

The longer the reaction proceeds, the larger the amount of the higher-functional uretonimine oligomers, i.e., greater than 3-functional, that is formed. As more MDI is consumed and converted to uretonimines, the isocyanate value of the first polyisocyanate composition is reduced because reactive isocyanate groups are reacted with one another. As understood by those of ordinary skill in the art, the isocyanate value refers to a weight percentage of reactive isocyanate groups in the first polyisocyanate composition. The isocyanate value can be determined by the following, well-known equation:

$$Isocyanate Value = \% NCO groups = \frac{42 \times f}{Mw} \times 100 ,$$

wherein 42 is the molecular weight of the NCO groups, f is functionality and refers to the number of reactive groups in the first polyisocyanate composition, and Mw is the molecular weight of the polyisocyanate. For example, 4,4′-MDI has a molecular weight of 250.26 and a functionality of 2 resulting in the isocyanate value, or % NCO groups, of 33.6.

The reaction of the first polyisocyanate composition is quenched with a quenching agent described below. The reaction is quenched to produce a stable intermediate composition having an intermediate isocyanate value of from about 25.5 to about 28.5. Preferably, the intermediate isocyanate value is from about 25.5 to about 28, and more preferably from about 26.0 to about 28. Achieving intermediate isocyanate values within the above ranges has a dramatic impact on the stability of the uretonimine-modified isocyanate composition. When the values fall outside of the above ranges, the stability begins to deteriorate and becomes less acceptable in the commercial marketplace. Therefore, the manufacturing of the uretonimine-modified isocyanate composition is controlled to ensure the desired intermediate isocyanate value is achieved.

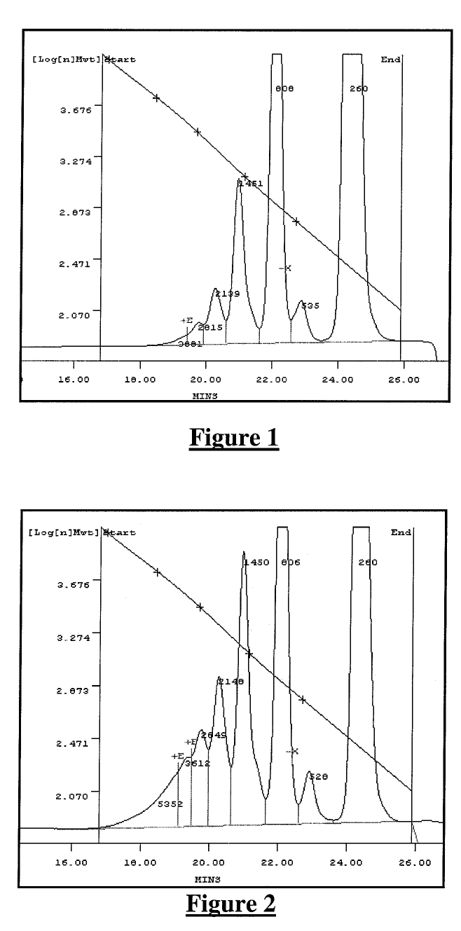

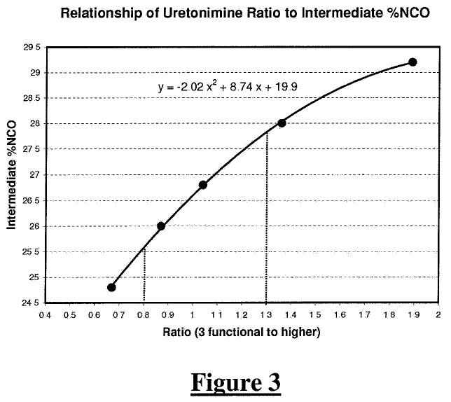

The uretonimine-modified isocyanate composition also has a ratio of 3-functional uretonimine oligomers to higher-functional uretonimine oligomer's of from about 0.8 to about 1.5. The ratio of 3-functional uretonimine oligomers to higher-functional uretonimine oligomers is determined by analyzing the uretonimine-modified isocyanate composition with gel permeation chromatography (GPC). Referring to FIGS. 1 and 2, graphs of GPC traces are shown for the uretonimine-modified isocyanate composition formed according to the subject invention after a first time period and a second time period of formation. The right most peak shown in the traces represents unreacted 4,4′-MDI and 2,4′-MDI, shown at about 24.3 minutes. The next largest peak to the left represents the 3-functional uretonimine oligomers, shown at about 22.0 minutes. A small peak appears between these two larger peaks at about 23.0 minutes and is an unknown. The remaining peaks to the left of the 3-functional uretonimine peak represent the higher-functional oligomers from about 19.3 minutes to about 21.5. The ratio of 3-functional uretonimine oligomers to higher-functional uretonimine oligomer's is determined from the GPC by measurement of the area under the peaks. For example, if the ratio is 1:1, then the area under the peak of the 3-functional uretonimine oligomers is the same as the area under the peaks of the higher-functional uretonimine oligomers. Preferably, the ratio of 3-functional uretonimine oligomers to higher-functional uretonimine oligomer's is about 0.8:1.3. More preferably, the ratio is about 1:1.

The ratio of 3-functional uretonimine oligomers to higher-functional uretonimine oligomers depends upon the intermediate isocyanate value of the intermediate composition. As the intermediate isocyanate value decreases the ratio of 3-functional uretonimine oligomers to higher-functional uretonimine oligomers decreases. The following table summarizes a GPC analysis of intermediate compositions illustrating the relationship of the ratio of 3-functional uretonimine to higher functional uretonimine oligomers to intermediate isocyanate value. FIG. 3 is a graphical representation of this relationship.

TABLE 1

| | Ratio 3-functional |
|---|---|
| Intermediate | Uertonimine to Oligomeric |
| % NCO Value | Uretonimines |
| 29.2 | 1.89 |
| 28.0 | 1.36 |
| 26.8 | 1.04 |
| 26.0 | .87 |
| 24.8 | .67 |

After the intermediate composition reaches the desired intermediate isocyanate value and the reaction is quenched, a second polyisocyanate composition is added to the intermediate composition. The second polyisocyanate composition may be similar to the first polyisocyanate composition described or it may include pure 4,4′-MDI, 2,4′-MDI, or other isocyanate compositions. The second polyisocyanate composition is added in an amount sufficient to produce the uretonimine-modified isocyanate composition having a desired final isocyanate. For example, the uretonimine-modified isocyanate composition has a final isocyanate value of from about 29.0 to about 29.5. It was discovered that the low temperature stability of the composition is sensitive to the final isocyanate value, especially at an isocyanate value of about 29.5. If the final isocyanate value exceeds about 29.5, then the low temperature stability of the composition will likely be reduced. Preferably the final isocyanate value is from about 29.0 to about 29.5. More preferably the final isocyanate value is about 29.2.

The amount of uretonimine and uretonimine oligomers in the final product depends upon the final isocyanate value of the uretonimine-modified isocyanate composition, and thus on the amount of second polyisocyanate composition added. As more first polyisocyanate composition is added the final isocyanate value increases and the relative amount of uretonimine and uretonimine oligomers decreases. It is desirable to add the second polyisocyanate composition in an amount of from about 10 to about 60 weight percent based on the total weight of the first polyisocyanate composition. More preferably, from about 30 to about 50 weight percent.

The 4,4′-MDI can be produced by any of the commonly employed processes including the distillation of crude mixtures of isocyanate obtained by phosgenating a mixture of polyamines generally obtained by acid condensation of aniline and formaldehyde. However, such processes result in acidic impurities, specifically hydrolysable chlorides, being present in the 4,4′-MDI. These impurities have deleterious effects on the catalyst used to promote the MDI carbodiimidization reaction, resulting in a slower reaction rate, a longer reaction time, and an increased concentration of uretdione fin the composition. An increased concentration of uretdione reduces the storage lifetime of the composition.

In order to counteract such effects, the amount of acidic impurity present in the first polyisocyanate composition is determined prior to reacting the first polyisocyanate composition. Based upon the amount of the impurity in the first polyisocyanate composition, the amount of the catalyst is adjusted to increase the rate of reaction and to minimize the formation of uretdione. For example, if the amount of acidic impurity present in the first polyisocyanate composition is less than about 5 parts per million, then the catalyst may be present in an amount of from about 2.0 to about 5.0 parts per million. If the amount of the acidic impurity in the first polyisocyanate composition is between about 5 to 10 parts per million, then the amount of the catalyst present is from about 3.5 to about 8.5 parts per million.

As described above, the quenching agent quenches the reaction by deactivating the catalyst, thereby reducing or preventing further reaction of the 4,4′-MDI to form carbodiimide and further to form uretonimine. The quenching agent also stabilizes the uretonimine-modified isocyanate composition over increased storage periods at temperatures above 30° C. The quenching agent must be sufficiently strong to prevent the reactivation of the catalyst and is used in an amount based upon the amount of catalyst used, the reactivity of the first polyisocyanate composition, and the strength of the quenching agent. The quenching agent is used in an amount of from about 1 to about 20 parts by weight based per part by weight of the catalyst used, preferably from about 2 to about 10 parts by weight.

Useful quenching agents include aliphatic and aromatic acid chlorides such as acetyl chloride, benzoyl chloride and benzenesulfonyl chloride, oxalyl chloride, adipyl chloride, sebacyl chloride and carbonyl chloride. Also inorganic acids such as perchloric acid, hydrochloric acid, peracetic acid, acetic acid, oxalic acid, citric acid, formic acid, ascorbic acid, benzoic acid, and sulfuric acid, and strong organic acids such as trifluoromethane sulfonic acid, toluenesulfonic acid, and trifluoroacetic acid may be employed. Chloroformates may also be employed such as methyl chloroformate, ethyl chloroformate, isopropyl chloroformate, n-butyl chloroformate, isopropyl chloroformate, n-butyl chloroformate, sec-butyl chloroformate and diethylene glycol bis chloroformate. Most preferably, the quenching agent is selected from at least one of trifluoromethanesulfonic acid and perchloric acid.

As more catalyst is added to increase the rate of reaction of the 4,4′-MDI and to maintain the lower reaction temperature of about 105° C., more quenching agent is required to deactivate the catalyst. Adding the quenching agent in large amounts impacts the final uretonimine-modified isocyanate composition and impacts products manufactured therefrom. Therefore, it has been discovered that a co-catalyst, different than the catalyst, may be added to the first polyisocyanate composition to increase the rate of reaction and to achieve the desired intermediate isocyanate value and ratio of uretonimine oligomers without requiring larger amounts of the quenching agent. Generally, the co-catalyst has a lower reactivity or strength than that of the catalyst. Additional quenching agent is not needed to deactivate the co-catalyst. Further, the co-catalyst may be added in larger amounts than the catalyst and not require additional quenching agent to deactivate the co-catalyst.

The co-catalyst is added in an amount of from about 50 to about 1500 parts per million, preferably from about 100 to about 1250, more preferably from about 200 to about 1000 parts per million. The co-catalyst is preferably a phosphite, comprised of aliphatic, aromatic, or mixed aliphatic and aromatic groups. Examples of preferred cocatalysts include triphenyl phosphite, tributyl phosphite, phenyl diisodecyl phosphite, and diphenyl isodecyl phosphite.

The following examples illustrate the production of the uretonimine-modified isocyanate composition, according to the subject invention and illustrating certain properties of the uretonimine-modified isocyanate composition, as presented herein, are intended to illustrate and not limit the invention.

### EXAMPLES

Uretonimine-modified isocyanate compositions are produced according to the compositions illustrated in Table 1. The components that form the composition are listed in parts by weight, unless otherwise indicated. In each example in Table 1, a polyisocyanate composition comprising about a 96:4 Wt. % ratio of 4,4′MDI and 2,4′-MDI was combined with about 3 to 8 ppm of phospholene oxide catalyst, then reacted at about 105 to about 108° C. until the desired intermediate % NCO value was reached. About 50 ppm of catalyst stopper was added and the mixture was cooled to 50° C. If the intermediate % NCO value was less than 29.0, additional MDI in the ratio of 94% 4,4′-MDI isomer to 6% 2,4′-MDI isomer was added to achieve the final desired % NCO value.

TABLE 1
Uretonimine-Modified Isocyanate Compositions

| | Ex. 1 | Ex. 2 | Ex. 3 | Ex. 4 | Ex. 5 | Ex. 6 |
|---|---|---|---|---|---|---|
| 4,4′-MDI, % | 93.80 | 93.80 | 93.80 | 93.80 | 93.80 | 93.80 |
| 2,4′-MDI, % | 6.20 | 6.20 | 6.20 | 6.20 | 6.20 | 6.20 |
| Catalyst (ppm) | 5.1 | 5.1 | 5.1 | 6.0 | 6.0 | 6.0 |
| Reaction Temp., ° C. | 105–108 | 105–108 | 105–108 | 105–108 | 105–108 | 105–108 |
| Duration, hours | 2.80 | 4.2 | 5.3 | 2.3 | 2.4 | 2.6 |
| Intermed. % NCO | 29.5 | 27.0 | 25.1 | 27.9 | 27.5 | 27.0 |
| Final % NCO | 29.5 | 29.4 | 29.7 | 29.3 | 29.3 | 29.4 |
| Stability, days @ 5° C. | 2 | 6 | 2 | 5 | 6 | 4 |

The polyisocyanate composition comprises a mixture Lupranate® M and Lupranate® MI, both commercially available from BASF Corporation.

Examples 1 to 6 in Table 1 are subjected to an accelerated low temperature stability test, to determine the sensitivity of each sample to solids formation. Samples that survive the longest number of days solids-free at 5° C. exhibit the best low temperature stability. Examples with an intermediate % NCO value of between 27 and 28, and a final % NCO value of no higher than about 29.4%, exhibit the best low temperature stability.

The uretonimine-modified isocyanate compositions in Table 2 were prepared using a process similar to that used for compositions in Table 1, except that a different ratio of 4,4′-MDI to 2,4′-MDI is used and the reaction temperature is varied. The polyisocyanate compositions comprise about a 98.5:1.5 wt. % ratio of 4,4′MDI and 2,4′-MDI and the reaction temperature is either 120° C. or 110° C.

TABLE 2
Uretonimine-Modified Isocyanate Compositions

| | Ex. 7 | Ex. 8 |
|---|---|---|
| 4,4′-MDI, % | 98.5 | 98.5 |
| 2,4′-MDI, % | 1.5 | 1.5 |
| Catalyst (ppm) | 3.4 | 7.0 |
| Reaction Temp., ° C. | 120 | 110 |
| Duration, hours | 2.8 | 3.8 |
| Intermed. % NCO | 27.7 | 27.7 |
| Final % NCO | 29.2 | 29.2 |
| Stability, days @ 7° C. | 2–3 | 5 |

The final uretonimine-containing compositions in Table 2 are less temperature stable than those in Table 1, due to the lower wt. % of 2,4′-MDI, so the low temperature stability test is carried out at 7° C. instead of 5° C. Examples 7 and 8 illustrate the effect of reaction temperature on low temperature stability. Example 8, prepared at the lower reaction temperature of 110° C., provides for a more stable uretonimine composition.

The uretonimine-modified isocyanate compositions in Table 3 are prepared using a process similar to that used for compositions in Table 1, except that the reaction temperature is kept constant at 105° C. and the final % NCO value is kept constant at about 29.3. The intermediate % NCO value is allowed to vary, and the effect of this variation on low temperature stability is noted.

TABLE 3
Uretonimine-Modified Isocyanate Compositions

| | Ex. 9 | Ex. 10 | Ex. 11 | Ex. 12 |
|---|---|---|---|---|
| 4,4′-MDI, % | 93.80 | 93.80 | 93.80 | 93.80 |
| 2,4′-MDI, % | 6.20 | 6.20 | 6.20 | 6.20 |
| Catalyst (ppm) | 7.8 | 7.8 | 7.8 | 7.8 |
| Reaction Temp., ° C. | 105 | 105 | 105 | 105 |
| Duration, hours | 2.6 | 3.6 | 4.6 | 5.6 |
| Intermed. % NCO | 28.9 | 27.0 | 24.9 | 22.6 |
| Final % NCO | 29.4 | 29.3 | 29.3 | 29.3 |
| Stability, days @ 5° C. | 3–4 | 4–5 | <1 | <1 |

As indicated by the stability results in Table 3, good low temperature stability is obtained for compositions in which the intermediate % NCO value of the uretonimine-containing composition is between about 27.0 and 29.0. For best low temperature stability performance, the intermediate % NCO value of the uretonimine-containing composition is preferably between about 27.0 and 28.0.

The uretonimine-modified isocyanate compositions in Table 4 are prepared using a process similar to that used for compositions in Table 1.

TABLE 4
Uretonimine-Modified Isocyanate Compositions

| | Ex. 13 | Ex. 14 | Ex. 15 | Ex. 16 |
|---|---|---|---|---|
| 4,4′-MDI, % | 93.80 | 93.80 | 93.80 | 93.80 |
| 2,4′-MDI, % | 6.20 | 6.20 | 6.20 | 6.20 |
| Reaction Temp., | 106 | 106 | 106 | 106 |
| ° C. | | | | |
| Duration, hours | 2.5 | 2.5 | 2.5 | 4.0 |
| Intermed. % NCO | 26.0 | 26.0 | 26.0 | 28.5 |
| Final % NCO | 29.1 | 29.2 | 29.3 | 29.5 |
| Appearance after | Clear | Clear liquid, | Clear liquid, | Clear liquid, |
| storage at room | liquid, | solids-free | solids-free | solids-free |
| temperature | solids-free | | | |
| for >24 months | | | | |

Examples 13 to 16 are prepared with a range of intermediate % NCO values and final % NCO values. In all examples of Table 4, the compositions exhibited outstanding long-term shelf stability, remaining clear solids-free liquids even after storage for greater than 24 months at room temperature.

The uretonimine-modified isocyanate compositions in Table 5 are prepared using a process similar to that used for Examples 9 and 10 in Table 1, except that a different ratio of 4,4′-MDI to 2,4′-MDI is used and a co-catalyst, triphenylphosphite, is added to increase the rate of reaction. The intermediate % NCO value is allowed to vary, and the effect on low temperature stability is noted.

TABLE 5
Uretonimine-Modified Isocyanate Compositions

| | Ex. 17 | Ex. 18 |
|---|---|---|
| 4,4′-MDI, % | 93.8 | 93.8 |
| 2,4′-MDI, % | 6.2 | 6.2 |
| Catalyst (ppm) | 4.5 | 4.5 |
| Triphenylphosphite (ppm) | 813 | 813 |
| Reaction Temp., ° C. | 105 | 105 |
| Duration, hours | 2.5 | 3.5 |
| Intermed. % NCO | 28.3 | 25.8 |
| Final % NCO | 29.3 | 29.3 |
| Stability, days @ 5° C. | 7 | 3–4 |
| Days @ 5° C. when the | 16–17 | 4–6 |
| entire sample solidified | | |

From Table 5, the low temperature stability results indicate that a composition with an intermediate % NCO value of around 28.0 as provided in Example 17 is preferred over a composition with an intermediate % NCO value below 26.0 as provided in Example 18. However, it is to be appreciated that both Examples 17 and 18 improved stability as compared Examples 11 and 12.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of producing a uretonimine-modified isocyanate composition having increased low-temperature tolerance, said method comprising:
providing a first polyisocyanate composition having two or more isocyanate groups and comprising 4,4′-diphenylmethane diisocyanate (MDI);
reacting the first polyisocyanate composition at a temperature of from about 90° C. to about 115° C. and in the presence of a catalyst such that the isocyanate groups form carbodiimides for forming uretonimine and uretonimine oligomers;
quenching the reaction of the first polyisocyanate composition with a quenching agent to produce an intermediate composition having an intermediate isocyanate value of from about 25.5 to about 28.5; and
adding a second polyisocyanate composition to the intermediate composition in an amount sufficient to produce the uretonimine-modified isocyanate composition having a final isocyanate value of from about 29.0 to about 29.5.

2. A method as set forth in claim 1 wherein the step of quenching the reaction is further defined as quenching the reaction to produce the intermediate composition having the intermediate isocyanate value of from about 26.0 to about 28.0.

3. A method as set forth in claim 1 wherein the step of quenching the reaction is further defined as quenching the reaction to produce the intermediate composition having a ratio of 3-functional uretonimine oligomers to higher-functional uretonimine oligomer's of from about 0.8 to about 1.5 as a result of the intermediate composition achieving the intermediate isocyanate value.

4. A method as set forth in claim 1 wherein the step of reacting the first polyisocyanate composition is further defined as reacting at a temperature of about 105° C.

5. A method as set forth in claim 1 further comprising determining the amount of acidic impurity present in the first polyisocyanate composition prior to reacting the first polyisocyanate composition.

6. A method as set forth in claim 5 wherein the step of reacting the first polyisocyanate composition in the presence of the catalyst is further defined as reacting the first polyisocyanate composition in the presence of the catalyst in an amount based upon the amount of the acidic impurity present in the first polyisocyanate composition to increase the rate of reaction and to reduce the formation of uretdione dimers.

7. A method as set forth in claim 6 wherein the amount of the catalyst present is from about 2.0 to about 5.0 parts per million in response to determining the amount of the acidic impurity in the first polyisocyanate composition is less than about 5 parts per million.

8. A method as set forth in claim 6 wherein the amount of the catalyst present is from about 3.5 to about 8.5 parts per million in response to determining the amount of the acidic impurity in the first polyisocyanate composition is greater than about 5 parts per million.

9. A method as set forth in claim 5 further comprising adding a co-catalyst to the first polyisocyanate composition to increase the rate of reaction and to achieve the desired intermediate isocyanate value and ratio of uretonimine oligomers, while minimizing the formation of uretdione.

10. A method as set forth in claim 9 wherein the co-catalyst is added in an amount of from about 50 to about 1500 parts per million.

11. A method as set forth in claim 9 wherein the co-catalyst is further defined as a phosphite.

12. A method as set forth in claim 11 wherein the co-catalyst is selected from at least one of triphenyl phosphite, tributyl phosphite, phenyl diisodecyl phosphite, and diphenyl isodecyl phosphite.

13. A method as set forth in claim 1 wherein the catalyst is present in an amount of from about 1 to about 10 parts per million.

14. A method as set forth in claim 1 wherein the catalyst is selected from at least one of phospholene, phospholidine, phospholene oxide, and phospholidine oxide.

15. A method as set forth in claim 1 wherein the quenching agent is selected from at least one of trifluoromethanesulfonic acid and perchloric acid.

16. A method as set forth in claim 1 wherein the first polyisocyanate composition comprises 4,4′-MDI in an amount of from about 85 to less than 98 parts by weight based on 100 parts by weight of the polyisocyanate composition.

17. A method as set forth in claim 1 wherein the first polyisocyanate composition comprises 2,4′-MDI in an amount of greater than 2 to about 15 parts by weight based on 100 parts by weight of the polyisocyanate composition.

18. A method as set forth in claim 1 wherein the second polyisocyanate composition is present in an amount of from about 10 to about 60 parts by weight based on 100 parts of the uretonimine-modified isocyanate composition.

19. A method of producing a uretonimine-modified isocyanate composition having increased low-temperature tolerance, said method comprising:
providing a first polyisocyanate composition comprising 4,4′-diphenylmethane diisocyanate (MDI) in an amount of from about 85 to less than 98 parts by weight and 2,4′-MDI in an amount of greater than 2 to about 15 parts by weight, both based on 100 parts by weight of the polyisocyanate composition;
determining an amount of acidic impurity present in the first polyisocyanate composition;
adding a catalyst selected from at least one of phospholene, phospholidine, phospholene oxide, and phospholidine oxide in an amount based upon the amount of the impurity present;
adding a co-catalyst different than the catalyst;
reacting the first polyisocyanate composition at a temperature of from about 90° C. to about 115° C. in the presence of the catalyst and the co-catalyst; and
quenching the reaction of the first polyisocyanate composition with a quenching agent to produce an intermediate composition having an intermediate isocyanate value of from about 25.5 to about 28.5.

20. A method as set forth in claim 19 wherein the catalyst is added in an amount of from about 2.0 to about 5.0 parts per million in response to determining the amount of the acidic impurity being less than about 5 parts per million.

21. A method as set forth in claim 19 wherein the catalyst is added in an amount of from about 3.5 to about 8.5 parts per million in response to determining the amount of the acidic impurity being greater than about 5 parts per million.

22. A method as set forth in claim 19 wherein the co-catalyst is added in an amount of from about 50 to about 1500 parts per million.

23. A method as set forth in claim 22 wherein the co-catalyst is further defined as a phosphite.

24. A method as set forth in claim 22 wherein the co-catalyst is selected from at least one of triphenyl phosphite, tributyl phosphite, phenyl diisodecyl phosphite, and diphenyl isodecyl phosphite.

25. A method as set forth in claim 19 wherein the catalyst is present in an amount of from about 1 to about 10 parts per million.

26. A method as set forth in claim 19 further comprising adding a second polyisocyanate composition to the intermediate composition in an amount sufficient to produce the uretonimine-modified isocyanate composition having a final isocyanate value of from about 29.0 to about 29.5.

27. A method as set forth in claim 19 wherein the quenching agent is selected from at least one of trifluoromethanesulfonic acid and perchloric acid.

28. A uretonimine-modified isocyanate composition having increased low-temperature tolerance, said uretonimine-modified isocyanate composition comprising:
an intermediate composition having an intermediate isocyanate value of from about 25.5 to about 28.5 and having a ratio of 3-functional uretonimine oligomers to higher-functional uretonimine oligomers of from about 0.8 to about 1.5 produced from a first polyisocyanate composition having two or more isocyanate groups and comprising 4,4′-diphenylmethane diisocyanate (MDI) that is reacted at a temperature of from about 90° C. to about 115° C. and in the presence of a catalyst such that the isocyanate groups form uretonimine oligomers; and
a second polyisocyanate composition in an amount sufficient to produce the uretonimine-modified isocyanate composition having a final isocyanate value of from about 29.0 to about 29.5.

29. A method as set forth in claim 28 wherein the second polyisocyanate composition is present in an amount of from about 10 to about 60 parts by weight based on 100 parts of the uretonimine-modified isocyanate composition.
